(19) United States
(12) Patent Application Publication
(10) Pub. No.: US 2023/0418838 A1
(43) Pub. Date: Dec. 28, 2023

(54) SYSTEM AND METHOD FOR PROVIDING NESTED BLOCKCHAIN

(71) Applicants: Vilma Mattila, London (GB); Pratik Gauri, London (GB); Prateek Dwivedi, London (GB)

(72) Inventors: Vilma Mattila, London (GB); Pratik Gauri, London (GB); Prateek Dwivedi, London (GB)

(73) Assignee: 5ire LLP, London (GB)

(21) Appl. No.: 17/850,605

(22) Filed: Jun. 27, 2022

(51) Int. Cl. G06F 16/27; G06F 16/22

(52) U.S. Cl. CPC G06F 16/273; G06F 16/2246

(57) ABSTRACT

A system and method for providing nested blockchain configured to process transactions is disclosed. The system comprises a computing device having a computer-readable medium and one or more processors coupled to the computer-readable medium to execute a set of instructions configured to process transactions at scale. The nested blockchain platform comprises one or more nodes to create concurrent blocks and maintain smaller chains, which nests the smaller chains together. The system processes the transactions at scale where nodes form autonomous groups and concurrently process transactions and form their own chains. The nested chain includes a linear data structure. Each block in the nested blockchain is structured in the form of hash of blocks, previous hash, and fire block hash. Further, the nested blockchain incorporates multiple linear chains in between the firechain depending on the requirement and transactional load on the network.

### FIELD OF THE INVENTION

The present invention generally relates to blockchain technology. More specifically, the present invention relates to a computer-implemented system and method for providing nested blockchain configured to process transactions using nodes by creating concurrent blocks and maintaining smaller chains forming a nested blockchain platform.

### BACKGROUND

Blockchain is a database that stores encrypted information in a chain of blocks. Each block contains a cryptographic hash of the previous block, a timestamp, and transaction data. It is a decentralized ledger of all transactions across a peer-to-peer network. Conventional blockchain is linear in nature and each block is connected to its previous block through a cryptographic hash. It facilitates the process of recording transactions and tracking assets in a business network. Moreover, this network employs nested blockchain architecture for facilitating faster and cheaper transactions. The nested blockchain involves a main block with multiple levels connected to each other to form a parent-child chain connection.

Few existing patent references attempt to address the problems cited in the background as prior art over the presently disclosed subject matter are explained as follows:

A prior art U.S. Ser. No. 10/764,034 B2 to Thomas Thompson, entitled “Method and system for facilitating data transfer between blockchains” discloses methods, systems, and techniques for facilitating data transfer between blockchains, Data is sent from a first blockchain to a second blockchain. The data includes lineage verification data that permits the second blockchain to verify a lineage of at least one block of the first blockchain; a proper subset of all non-header data stored using at least one block; and validity verification data that permits the second blockchain to verify the validity of the proper subset of all non-header data sent to the second blockchain from the first blockchain. The proper subset of non-header data maybe a slice of state data of an application stored in the first blockchain. The second blockchain verifies the lineage and validity of the data it receives and creates a new block having non-header data comprising the data it received.

Another prior art U.S. Ser. No. 10/693,654 B2 to Thomas Thompson, entitled “Method and system for hosting a new blockchain using an existing blockchain node” disclose methods, systems, and techniques for generating a new blockchain involve storing, in an existing blockchain, a genesis block of the new blockchain; and hosting the new blockchain using the genesis block of the new blockchain as a first block of the new blockchain. The storing may be done before the hosting, such as when the existing blockchain generates the genesis block of the new blockchain itself and subsequently causes the new blockchain to be hosted. Alternatively, the hosting may be done before the storing, such as when a node foreign to the existing blockchain generates the genesis block of the new blockchain and hosts the new blockchain, and the genesis block of the new blockchain is subsequently introduced to and stored in the existing blockchain.

Another prior art U.S. Ser. No. 10/892,887 B2 to Thomas Thompson, entitled “Method and system for storing a binary large object” discloses methods, systems, and techniques for storing a binary large object involve receiving, at a first node comprising part of a first blockchain, the binary large object; hashing the binary large object; sending the binary large object from the first node to at least one other node that is part of the first blockchain without using the first blockchain; and after the binary large object has been disseminated to at least the number of nodes on the first blockchain required to achieve consensus, storing a hash of the binary large object on the first blockchain. Sending the binary large object involves disseminating the binary large object to at least a number of nodes on the first blockchain required to achieve consensus.

Though the above existing prior art discloses various methods, systems, and techniques to facilitate data transfer using blockchain, none of them disclose a system that processes the transactions at a scale where nodes form autonomous groups and concurrently process transactions and form their own chains. Also, they lack to disclose a system that incorporates multiple chains in between the blockchain depending on the requirement and transactional load on the network.

In light of the above-mentioned drawback, there is a need for a system and method that processes transactions via a nested blockchain platform. Also, there is a need for a system that processes the transactions at the scale where nodes forms form autonomous groups and concurrently process transactions and form their own chains. Further, there is a need for a system that incorporates multiple chains in between the blockchain depending on the requirement and transactional load on the network.

### SUMMARY OF THE INVENTION

The present invention generally discloses a computer-implemented system and method for processing transactions using a nested blockchain system. Also, the present invention discloses the nested blockchain system or nested blockchain platform having nodes that creates concurrent blocks and maintain smaller chains that are later merged to a sustainability-driven blockchain platform or firechain.

In one embodiment, the system of a sustainability-driven blockchain or firechain or firechain is executed in a network environment for providing the nested blockchain platform. The system runs in the computer-implemented network environment configured to provide the nested blockchain. The nested blockchain is a fusion of one or more firechain blocks and smaller chains. In one embodiment, the system processes transactions using one or more nodes to create concurrent blocks and maintains smaller chains forming the nested blockchain platform. In one embodiment, the system is an application software or web-based application or mobile application or desktop application

In one embodiment, the network environment comprises one or more user devices. Each user device is associated with a user. In one embodiment, the user device is installed with the application software. The system further comprises a network and a blockchain transaction management system. In one embodiment, the user device is enabled to access the blockchain transaction management system via the network. In one embodiment, the user device enables the user to access one or more services provided by the system. In one embodiment, the user device is at least any one of a smartphone, a mobile phone, a tablet, a laptop, a desktop, and/or other suitable hand-held electronic communication devices. In one embodiment, the user device comprises a storage medium in communication with the network to access the blockchain transaction management system. In an embodiment, the network could be Wi-Fi, WiMAX, wireless local area network (WLAN), satellite networks, cellular networks, private networks, and the like.

In one embodiment, the blockchain transaction management system comprises a computing device and one or more databases in communication with the computing device. In one embodiment, the computing device is a server. In one embodiment, the computing device could be a cloud server. In one embodiment, the server could be operated as a single computer. In some embodiments, the computer could be a touchscreen and/or non-touchscreen and adopted to run on any type of OS, such as iOS™, Windows™, Android™ Unix™, Linux™, and/or others. In one embodiment, the plurality of computers is in communication with each other, via networks. Such communication is established via any one of an application software, a mobile application, a browser, an OS, and/or any combination thereof.

In one embodiment, the database is in communication with the computing device via the network. In one embodiment, the database is accessible by the computing device. In another embodiment, the database is integrated into the computing device or separate from it. In one embodiment, the computing device comprises a computer-readable medium or memory unit and one or more processors coupled to the computer-readable medium. The memory unit stores a set of instructions executable by the processor configured to process transactions using nodes. The memory unit could be RAM, ROM (including EPROM, EEPROM, PROM). In one embodiment, the user devices are configured to access the services provided by the computing device via the network. In one embodiment, the computing device is configured to process the transactions in the nested blockchain platform.

In one embodiment, a nested blockchain platform is provided with structured blocks for processing transactions. In one embodiment, the nested blockchain comprises a plurality of nodes that create concurrent blocks and maintain smaller chains. In one embodiment, the nested blockchain is later merged into the firechain system. In one embodiment, the firechain system is a tree-structured blockchain followed by a fire block, which nests the smaller chains together. In one embodiment, the system processes the transactions at scale where nodes form autonomous groups and concurrently process the transactions and form their own chains.

In one embodiment, the nested blockchain comprises a linear data structure. In one embodiment, the nested blockchain incorporates multiple linear chains in between at least two firechain blocks or fire blocks depending on the requirement and transactional load on the network. In one embodiment, the smaller chains are merged into the firechain. In one embodiment, the first fire block is structured in the form of hash of blocks, previous hash, and fire block hash in each block. In one embodiment, the blocks in the smaller chains are structured with a hash of each block or Merkle root, previous chain block or chain block, and previous fire block or fire block. The remaining blocks of smaller chain include hash of block or Merkle root, chain block, and fire block. Similarly, the last firs-block is structured in the form of hash of block or previous hash in each block, previous hash, and fire block hash. In one embodiment, the Merkle root is to verify the data blocks in the nested firechain.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a computer-implemented system executed in a network environment for processing transactions using a nested blockchain platform in an embodiment of the present invention.

FIG. 2 shows the structured blocks of the nested blockchain platform in one embodiment of the present invention.

### DETAILED DESCRIPTION OF EMBODIMENTS

The present invention is best understood by reference to the detailed figures and description set forth herein.

It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

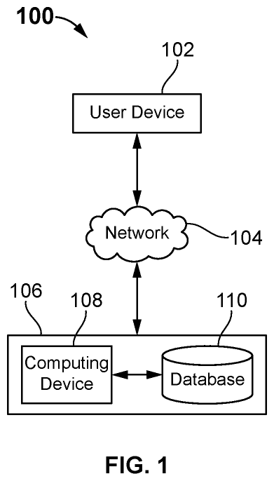

Referring to FIG. 1, a computer-implemented system of a sustainability-driven fifth-generation blockchain or firechain or firechain executed in a network environment 100 for providing nested blockchain platform, according to one embodiment of the present invention. The system runs in the computer-implemented network environment 100 configured to provide the nested blockchain. The nested blockchain is a fusion of one or more firechain blocks and smaller chains. In one embodiment, the system processes transactions using one or more nodes to create concurrent blocks and maintains smaller chains forming the nested blockchain platform. In one embodiment, the system is an application software or web-based application or mobile application or desktop application.

In one embodiment, the network environment 100 comprises one or more user devices 102. Each user device 102 is associated with a user. In one embodiment, the user device 102 is installed with the application software. The system further comprises a network 104 and a blockchain transaction management system 106. In one embodiment, the user device 102 is enabled to access the blockchain transaction management system 106 via the network 104. In one embodiment, the user device 102 enables the user to access one or more services provided by the system. In one embodiment, the user device 102 is at least any one of a smartphone, a mobile phone, a tablet, a laptop, a desktop, and/or other suitable hand-held electronic communication devices. In one embodiment, the user device 102 comprises a storage medium in communication with the network 104 to access the blockchain transaction management system 106. In an embodiment, the network 104 could be Wi-Fi, WiMAX, wireless local area network (WLAN), satellite networks, cellular networks, private networks, and the like.

In one embodiment, the blockchain transaction management system 106 comprises a computing device 108 and one or more databases 110 in communication with the computing device 108. In one embodiment, the computing device 108 is a server. In one embodiment, the computing device 108 could be a cloud server. In one embodiment, the server could be operated as a single computer. In some embodiments, the computer could be a touchscreen and/or non-touchscreen and adopted to run on any type of OS, such as iOS™, Windows™, Android™, Unix™, Linux™, and/or others. In one embodiment, the plurality of computers is in communication with each other, via networks. Such communication is established via any one of an application software, a mobile application, a browser, an OS, and/or any combination thereof.

In one embodiment, the database 110 is in communication with the computing device 108 via the network 104. In one embodiment, the database 110 is accessible by the computing device 108. In another embodiment, the database 110 is integrated into the computing device 108 or separate from it. In some embodiments, the database 110 resides in a connected server or a cloud computing service. Regardless of location, the database 110 comprises a memory to store and organize certain data for use by the computing device 108.

In one embodiment, the computing device 108 comprises a computer-readable medium or memory unit and one or more processors coupled to the computer-readable medium. The memory unit stores a set of instructions executable by the processor configured to process transactions using nodes. The memory unit could be RAM, ROM (including EPROM, EEPROM, PROM). In one embodiment, the user devices 102 are configured to access the services provided by the computing device 108 via the network 104. In one embodiment, the computing device 108 is configured to process the transactions in the nested blockchain platform.

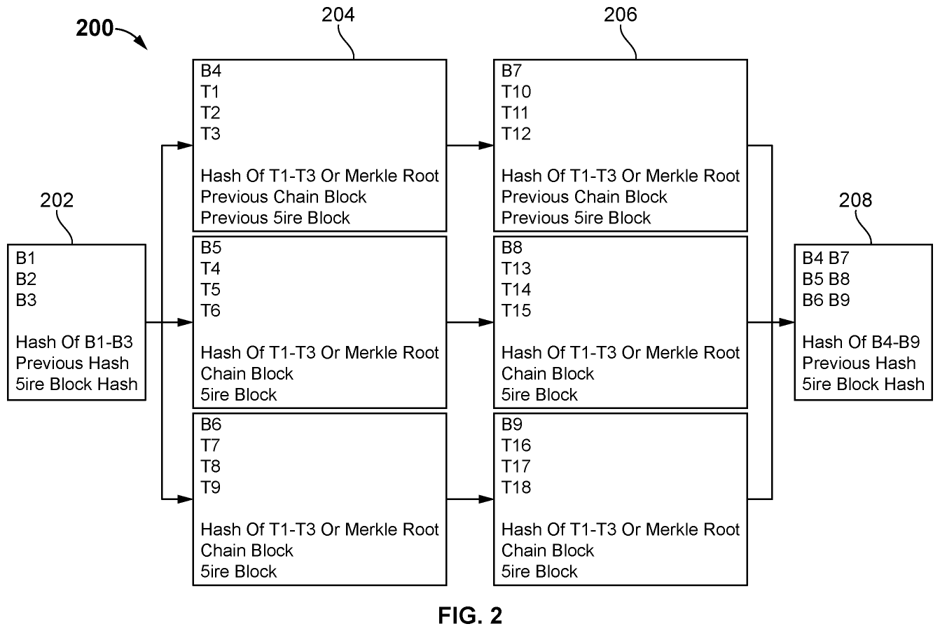

Referring to FIG. 2, a nested blockchain platform 200 with structured blocks for processing transactions, according to one embodiment of the present invention. In one embodiment, the nested blockchain 200 comprises a plurality of nodes that create concurrent blocks and maintain smaller chains. In one embodiment, the nested blockchain 200 is later merged into the firechain system. In one embodiment, the firechain system is a tree-structured blockchain followed by a fire block, which nests the smaller chains together. In one embodiment, the system processes the transactions at scale where nodes form autonomous groups and concurrently process the transactions and form their own chains.

In one embodiment, the nested blockchain 200 comprises a linear data structure. In one embodiment, the nested blockchain 200 incorporates multiple linear chains (204 and 206) in between at least two firechain. In one embodiment, the nested blockchain 200 incorporates multiple linear chains (204 and 206) in between at least two firechain blocks or fire blocks (202 and 208) depending on the requirement and transactional load on the network. In one embodiment, the smaller chains (204 and 206) are merged into the firechain.

In one embodiment, the first fire block is structured in the form of one or more hash of blocks, previous hash, and fire block hash in each block. For example, the first fire block may be structured in the form of hash of blocks B1-B3, previous hash, and fire block hash in each block. In one embodiment, the blocks in the smaller chain includes a hash of block or Merkle root, previous chain block or chain block, and previous fire block or fire block. For example, the blocks in the smaller chain may include hash of t1-t3 or Merkle root, previous chain block or chain block, and previous fire block or fire block with B4 hash. The remaining blocks of smaller chain include a hash of block or Merkle root, chain block, and fire block. For example, the remaining blocks of smaller chain may include a hash of t1-t3 or Merkle root, chain block, and fire block. Similarly, the last firs-block is structured in the form of hash of block or previous hash in each block, previous hash, and fire block hash. For example, the last firs-block is structured in the form of hash of B4-B9 or previous hash in each block, previous hash, and fire block hash. In one embodiment, the Merkle root is to verify the data blocks in the nested firechain.

Preferred embodiments of this invention are described herein, including the best mode known to the inventors for carrying out the invention. It should be understood that the illustrated embodiments are exemplary only and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A computer-implemented system of a sustainability-driven blockchain platform or firechain for providing nested blockchain, comprising:
a blockchain transaction management system comprising a computing device having a non-transitory memory and one or more processors coupled to the non-transitory memory configured to read one or more instructions from the non-transitory memory to process transactions at scale and one or more databases in communication with the computing device via a network configured to store a plurality of transaction details,
wherein the blockchain management system provides a nested blockchain having a plurality of nodes configured to,
create concurrent blocks and maintain one or more smaller chains, and
form autonomous groups of data blocks to concurrently process the transactions and form their own chains.

2. The system of claim 1, wherein the nested blockchain comprises a linear data structure.

3. The system of claim 1, wherein the nested blockchain comprises multiple linear chains between at least two firechain depending on the requirement and transactional load.

4. The system of claim 1, wherein the smaller chains are merged into the firechain.

5. The system of claim 1, wherein the nested blockchain is a tree-structured blockchain followed by one or more fire blocks, which nest the smaller chains together.

6. The system of claim 1, wherein the one or more fire blocks are structured in the form of hash of data blocks, previous hash, and blockchain hash.

7. The system of claim 1, wherein the concurrent blocks in the smaller chains are structured with a hash of each block or Merkle root, previous chain block or chain block, and previous fire block or fire block.

8. The system of claim 7, wherein the merkle root verifies the data blocks in the nested blockchain.

9. The system of claim 1, further comprises at least one user device configured to communicate with the computing device via the network using an application software or mobile application or web-based application or desktop application executed in the network environment.

10. The system of claim 9, wherein the user device is any one of a mobile phone, smart phone, a tablet, a laptop, a desktop, and/or other suitable hand-held electronic communication devices.

11. The system of claim 1, wherein the computing device is a cloud server.

12. The system of claim 1, wherein the network is any one of Wi-Fi, WiMAX, wireless local area network (WLAN), satellite networks, cellular networks, private networks, or other suitable communication networks.
